(19) United States
(12) Patent Application Publication
(10) Pub. No.: US 2018/0206120 A1
(43) Pub. Date: Jul. 19, 2018

(54) INDICATING ACTUAL PERSON SENDING A MESSAGE BASED ON PHYSICAL VALIDATION

(71) Applicant: International Business Machines Corporation, Armonk, NY (US)

(72) Inventor: JOHNNY SHIEH, Austin, TX (US)

(21) Appl. No.: 15/407,099

(22) Filed: Jan. 16, 2017

(51) Int. Cl. H04W 12/08; H04W 12/06; H04M 1/725; H04L 29/06

(52) U.S. Cl. CPC H04W 12/08; H04W 12/06; H04M 1/72577; H04M 2203/6018; H04L 63/0861; H04L 63/10; H04M 2203/6054; H04M 1/72547

(57) ABSTRACT

An apparatus for marking electronic messages includes an identity module that determines an identity of a device user attempting to send an electronic message from an electronic communication device of an authorized user and a verification module that verifies that the device user is an authorized proxy user. The apparatus includes a marking module that marks the electronic message being sent with an identifier in response to verifying that the device user is an authorized proxy user. The identifier signifies that the electronic message is from the authorized proxy user, and the identifier is in addition to an identifier associated with the authorized user.

### FIELD

The subject matter disclosed herein relates to electronic communications and more particularly relates to validating a sender of an electronic communication.

### BACKGROUND

In some instances, an authorized user of an electronic communication device, such as a smartphone, a smart watch, a tablet computer, etc. may be occupied and may be unable to send an electronic message, such as a text message or an email. In other instances, the authorized user may not want to send an electronic message based on safety concerns, such as when the authorized user is driving a vehicle. The authorized user, in some cases, may ask another person to send an electronic message on behalf of the authorized user. However, the person asked to send the electronic message may send a message with poor grammar, with slang, with phrasing different than language that the authorized user would send, etc. A party receiving the electronic message sent by this person other than the authorized user may be confused by the message or may not recognize that the authorized user is not sending the message.

### BRIEF SUMMARY

An apparatus for marking electronic messages is disclosed. An apparatus and computer program product also perform the functions of the apparatus. The apparatus includes an identity module that determines an identity of a device user attempting to send an electronic message from an electronic communication device of an authorized user and a verification module that verifies that the device user is an authorized proxy user. The apparatus includes a marking module that marks the electronic message being sent with an identifier in response to verifying that the device user is an authorized proxy user. The identifier signifies that the electronic message is from the authorized proxy user, and the identifier is in addition to an identifier associated with the authorized user.

A method for marking electronic messages includes determining identity of a device user attempting to send an electronic message from an electronic communication device of an authorized user and verifying that the device user is an authorized proxy user. The method includes marking the electronic message being sent with an identifier in response to verifying that the device user is an authorized proxy user. The identifier signifies that the electronic message is from the authorized proxy user, and the identifier is in addition to an identifier associated with the authorized user.

A computer program product for marking electronic messages includes a computer readable storage medium having program instructions embodied therewith. The program instructions are executable by a processor to cause the processor to determine an identity of a device user attempting to send an electronic message from an electronic communication device of an authorized user, to verify that the device user is an authorized proxy user, and to mark the electronic message being sent with an identifier in response to verifying that the device user is an authorized proxy user. The identifier signifies that the electronic message is from the authorized proxy user, and the identifier is in addition to an identifier associated with the authorized user.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings.

FIG. 1 is a schematic block diagram illustrating one embodiment of a system for message marking.

FIG. 2 is a schematic block diagram illustrating one embodiment of an apparatus for message marking.

FIG. 3 is a schematic block diagram illustrating another embodiment of an apparatus for message marking.

FIG. 4A is a diagram illustrating an intended electronic message.

FIG. 4B is a diagram illustrating an electronic message by an authorized proxy user marked with an identifier.

FIG. 5 is a schematic flow chart diagram illustrating one embodiment of a method for message marking.

FIG. 6 is a schematic flow chart diagram illustrating another embodiment of a method for message marking.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

An apparatus for marking electronic includes an identity module that determines an identity of a device user attempting to send an electronic message from an electronic communication device of an authorized user and a verification module that verifies that the device user is an authorized proxy user. The apparatus includes a marking module that marks the electronic message being sent with an identifier in response to verifying that the device user is an authorized proxy user. The identifier signifies that the electronic message is from the authorized proxy user, and the identifier is in addition to an identifier associated with the authorized user.

In one embodiment, the apparatus includes an authorization module that authorizes one or more authorized proxy users to send an electronic message from the electronic communication device. The one or more authorized proxy users are authorized by the authorized user of the electronic communication device. In another embodiment, the authorization module stores, for each authorized proxy user, verification data and an identifier. In the embodiment, the verification module verifies that the device user is an authorized proxy user based on the stored verification data associated with the authorized proxy user and the marking module marks the message with the stored identifier associated with the authorized proxy user. In another embodiment, the verification module receives an authorization from the authorized user in response to the identity module determining that the device user is not an authorized proxy user. The authorization authorizes the device user to send the electronic message from the electronic communication device.

In one embodiment, the identity module electronically determines an identity of the device user from identity data received through an input device in communication with the electronic communication device and the verification module compares the identity data with verification data associated with one or more authorized proxy users to determine whether the device user is an authorized proxy user. In a further embodiment, the identity data includes fingerprint data received from a fingerprint scanner and/or a touchscreen of the electronic communication device, an image of the device user received from a camera in communication with the electronic communication device, voice data received from a microphone in communication with the electronic communication device, and/or a password entered by the device user. In another embodiment, the identity module receives the identity data while the device user is inputting the electronic message. In another embodiment, the verification module evaluates identity data as the identity data is received by the identity module and generates an identity probability based on the identity data. The verification module verifies that the device user is an authorized proxy user in response to determining that the identity probability exceeds an identity threshold.

In one embodiment, the identity module repeats determining the identity of the device user and the verification module verifies that the device user is an authorized proxy user in response to each determination of identity, and the marking module marks each electronic message sent by the device user from the electronic communication device of the authorized user in response to continued verification that the device user is an authorized proxy user. In a further embodiment, the apparatus includes a blocking module that terminates authorization of the device user and blocks sending of electronic messages by the device user in response to the verification module determining that the device user not one or more of an authorized proxy user and the authorized user.

In one embodiment, the apparatus includes an authorization termination module that terminates authorization of the device user and stops marking electronic messages sent from the electronic communication device with an identifier in response to a timeout that returns the electronic communication device to a state requiring an authentication action by the authorized user, expiration of an authorization time-period and/or a determination that the authorized user is using the electronic communication device. In another embodiment, the authorization termination module prevents the device user from sending electronic messages from the electronic communication device in response to the authorization termination module terminating authorization. In another embodiment, the verification module also verifies that the device user is the authorized user and the marking module sends the electronic message without an identifier in response to the verification module verifying that the device user is the authorized user.

A method for marking electronic messages includes determining identity of a device user attempting to send an electronic message from an electronic communication device of an authorized user and verifying that the device user is an authorized proxy user. The method includes marking the electronic message being sent with an identifier in response to verifying that the device user is an authorized proxy user. The identifier signifies that the electronic message is from the authorized proxy user, and the identifier is in addition to an identifier associated with the authorized user.

In one embodiment, the method includes authorizing one or more authorized proxy users to send an electronic message from the electronic communication device. The one or more authorized proxy users are authorized by the authorized user of the electronic communication device. In another embodiment, the method includes storing, for each authorized proxy user, verification data and an identifier and verifying that the device user is an authorized proxy user is based on the stored verification data associated with the authorized proxy user. Marking the electronic message with the identifier includes marking the message with the stored identifier associated with the authorized proxy user.

In one embodiment, determining identity of the device user includes electronically determining identity of the device user from identity data received through an input device in communication with the electronic communication device and verifying that the device user is an authorized user includes comparing the identity data with verification data associated with one or more authorized proxy users to determine whether the device user is an authorized proxy user. In another embodiment, the identity data includes fingerprint data received from one or more of a fingerprint scanner and a touchscreen of the electronic communication device, an image of the device user received from a camera in communication with the electronic communication device, voice data received from a microphone in communication with the electronic communication device and/or a password received from the device user.

In one embodiment, determining identity of the device user includes receiving the identity data while the device user is inputting the electronic message and determining identity of the device user includes evaluating identity data as the identity data is received and the method includes generating an identity probability based on the identity data, where verifying that the device user is an authorized proxy user is in response to determining that the identity probability exceeding an identity threshold. In another embodiment, the method includes terminating authorization of the device user and stopping marking electronic messages sent from the electronic communication device with an identifier in response to a timeout that returns the electronic communication device to a state requiring an authentication action by the authorized user, expiration of an authorization time-period and/or a determination that the authorized user is using the electronic communication device.

A computer program product for marking electronic messages includes a computer readable storage medium having program instructions embodied therewith. The program instructions are executable by a processor to cause the processor to determine an identity of a device user attempting to send an electronic message from an electronic communication device of an authorized user, to verify that the device user is an authorized proxy user, and to mark the electronic message being sent with an identifier in response to verifying that the device user is an authorized proxy user. The identifier signifies that the electronic message is from the authorized proxy user, and the identifier is in addition to an identifier associated with the authorized user.

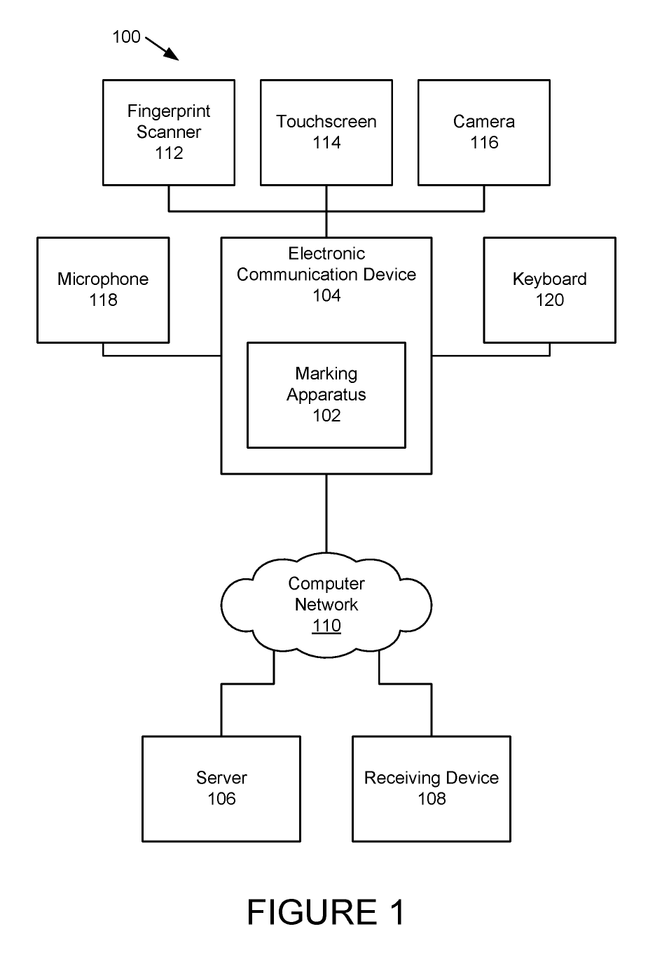

FIG. 1 is a schematic block diagram illustrating one embodiment of a system for message marking. The system 100 includes a marking apparatus 102, an electronic communication device 104, a server 106, a receiving device 108, a computer network 110, a fingerprint scanner 112, a touchscreen 114, a camera 116, a microphone 118 and/or a keyboard 120, which are described below.

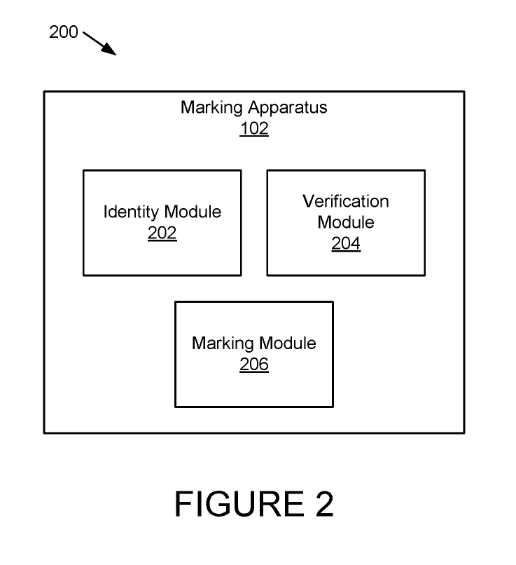

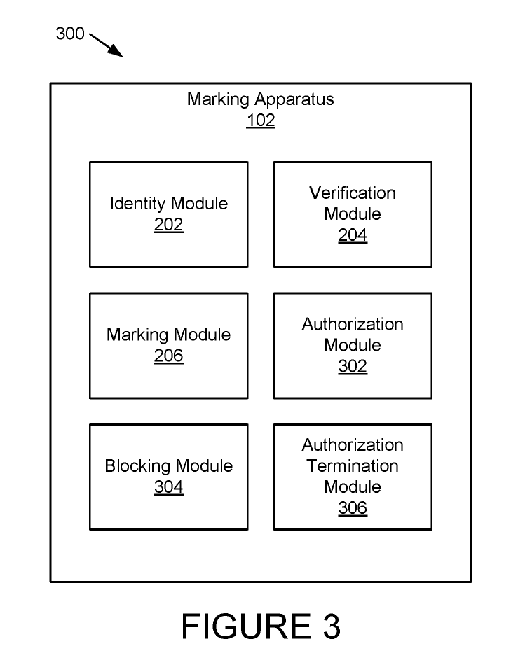

The system 100 includes a marking apparatus 102 that marks electronic messages with an identifier when an authorized proxy user sends the message instead of an authorized user of the electronic communication device 104. The marking apparatus 102 determines the identity of a device user that attempting to send an electronic message and also verifies that the device user is an authorized proxy user before marking the electronic message with the identifier. In some embodiments, the marking apparatus 102 blocks the device user from sending electronic messages where the device user is not an authorized proxy user or the authorized user. The marking apparatus 102 is discussed in more detail with respect to the apparatuses 200, 300 of FIGS. 2 and 3.

The electronic communication device 104 is a device capable of sending an electronic message. The electronic message, in one embodiment, is a text message sent using a short message service (“SMS”) or similar messaging system. The text message may include text or may include other items, such as a video, an image, special characters, etc. In another embodiment, the electronic message is an email message, which may include just text or may include attachments, such as documents, images, etc., may include links to webpages, documents, websites, etc.

An electronic message, as used herein, is any message sent electronically where an identifier may be attached so a person receiving the message may be notified that the device user sending the electronic message is someone different than the authorized user of the electronic communication device 104 that would normally be sending electronic messages. For example, where the electronic message is a text message, the receiving device 108 may receive the text message along with a telephone number of the authorized user. Where the electronic message is an email, the email would typically have an email address of the authorized user. The identifier associated with an authorized proxy user is in addition to the telephone number of a text or the email address of an email.

The electronic communication device 104 may be a smartphone, a mobile phone capable of sending texts, emails, etc. may be a tablet computer, a laptop computer, a smart watch, a desktop computer, or any other computing device capable of sending an electronic message on behalf of an authorized user. The electronic communication device 104 may include a processor, memory, and the like and includes an ability to communicate over a computer network 110.

The system 100 may also include one or more servers 106 which may facilitate sending electronic messages. For example, the server 106 may be part of a cellular telephone network in communication with the electronic communication device 104 and a portion of the computer network 110 may include a wireless cellular network. In another embodiment, the server 106 relays messages over the Internet. In another embodiment, the server 106 is in communication over a local area network (“LAN”), a wireless network, etc. and may relay the electronic message over the Internet or other computer network 110 to the receiving device 108. In one embodiment, the system 100 includes two or more servers 106 within a communication pathway between the electronic communication device 104 and the receiving device 108. One of skill in the art will recognize other servers 106 that may be part of the system 100.

In one embodiment, at least a portion of the marking apparatus 102 resides on the server 106. For example, the server may store a list of authorized proxy users along with verification data and an identifier for each authorized proxy user. In another embodiment, the electronic communication device 104 is a client and the marking apparatus 102 executes on the server 106 based on input from the client. One of skill in the art will recognize other parts of the marking apparatus 206 that may be on the server 106.

The system 100 includes a receiving device 108 capable of receiving electronic messages with an identifier. The receiving device 108 may include any electronic communication device capable of receiving an electronic message. For example, the receiving device 108 may include a smartphone, a smart watch, a tablet computer, a laptop computer, and the like.

The computer network 110 may include one or more networks, such as a LAN, a wide area network (“WAN”), a cellular network, the Internet, a wireless network, etc. The computer network 110 may include one or more servers 106, switches, routers, cabling, and other computer networking equipment. A communication pathway between the electronic communication device 104 and the receiving device 108 may include two or more computer networks 110.

The wireless connection(s) may be a mobile telephone network. The wireless connection(s) may also employ a Wi-Fi network based on any one of the Institute of Electrical and Electronics Engineers (“IEEE”) 802.11 standards. Alternatively, the wireless connection(s) may be a BLUETOOTH® connection. In addition, the wireless connection(s) may employ a Radio Frequency Identification (“RFID”) communication including RFID standards established by the International Organization for Standardization (“ISO”), the International Electrotechnical Commission (“IEC”), the American Society for Testing and Materials (“ASTM”), the DASH7 Alliance, and EPCGlobal.

Alternatively, the wireless connection(s) may employ a ZigBee connection based on the IEEE 802 standard. In one embodiment, the wireless connection(s) employs a Z-Wave connection as designed by Sigma Designs. Alternatively, the wireless connection(s) may employ an ANT and/or ANT+ connection as defined by Dynastream Innovations Inc. of Cochrane, Canada.

The wireless connection(s) may be an infrared connection including connections conforming at least to the Infrared Physical Layer Specification (“IrPHY”) as defined by the Infrared Data Association (“IrDA”). Alternatively, the wireless connection(s) may be a cellular telephone network communication. All standards and/or connection types include the latest version and revision of the standard and/or connection type as of the filing date of this application.

The system 100 may also include various input devices, such as a fingerprint scanner 112, a touchscreen 114, a camera 116, a microphone 118, a keyboard 120, etc. The input devices may be part of the electronic communication device 104, such as with a smartphone, a tablet computer, a laptop computer, etc., or may be separate from the electronic communication device 104, as depicted in FIG. 1, such as for a desktop computer, a workstation, etc. For example, the keyboard 120 maybe a separate keyboard in communication with the electronic communication device 104 or may appear on a touchscreen. The fingerprint scanner 112 may be separate from the electronic communication device 104, or may be built into the electronic communication device 104 as a separate device from the touchscreen 114, or fingerprint data may be available from the touchscreen 114. The camera 116 and microphone 118 may also be separate or may be a part of the electronic communication device 104. One of skill in the art will recognize other input devices and other configurations of input devices separate or part of the electronic communication device 104.

FIG. 2 is a schematic block diagram illustrating one embodiment of an apparatus 200 for message marking. The apparatus 200 includes one embodiment of a marking apparatus with an identity module 202, a verification module 204, and a marking module, which are described below.

The apparatus 200 includes an identity module 202 that determines an identity of a device user attempting to send an electronic message from an electronic communication device 104 of an authorized user. The identity module 202, in one embodiment, electronically determines an identity of the device user from identity data received through an input device in communication with the electronic communication device 104. For example, the input device may be a fingerprint scanner 112 or a touchscreen 114 capable of reading a fingerprint and in communication with the electronic communication device 104. The fingerprint scanner 112 or touchscreen 114 may be part of the electronic communication device 104, such as with a smartphone, smart watch, tablet computer, etc., or may be separate from the electronic communication device 104, such as with a desktop computer. In one embodiment, the identity module 202 uses identity data from the fingerprint scanner 112 or touchscreen 114 to identify the device user attempting to send an electronic message.

In another embodiment, the input device may be a camera 116 in communication with the electronic communication device 104. For example, the camera 116 may be a forward-facing camera of a smartphone, tablet, laptop, etc. or may be separate, such as a separate camera 116 connected, wired or wirelessly, to a desktop computer, workstation, etc. The camera 116 may be pointed at a location of the device user attempting to send an electronic message and an image from the camera 116 may be identity data used to identify the device user attempting to send an electronic message.

In one embodiment, the input device is a microphone 118 and voice data from the microphone 118 may be identity data used to identify the device user attempting to send an electronic message. The identity module 202 may identify a voice of the device user in proximity to the electronic communication device 104 and may also exclude sounds, voices, etc. deemed to be away from the electronic communication device 104. In another embodiment, the input device is a keyboard 120 and the device user may input a password as identity data through the keyboard 120 or via a keyboard on a touchscreen 114. One of skill in the art will recognize other input devices and other identity data that may be used to identify the device user attempting to send an electronic message.

In one embodiment, the identity module 202 receives the identity data while the device user is inputting the electronic message. For example, the identity module 202 may become active while the device user is inputting the electronic message. In another embodiment, the identity module 202 identifies the device user attempting to send an electronic message before the device user is able to input the electronic message.

The apparatus 200 includes a verification module 204 that verifies that the device user is an authorized proxy user. An authorized proxy user is a user other than the authorized user of the electronic communication device 104. In one embodiment, the authorized user may be the owner of the electronic communication device 104. For example, the authorized user may be the owner of a smartphone, a tablet computer, etc. and may therefore control access to the electronic communication device 104. In another embodiment, the authorized user is a user that has been authorized to use the electronic communication device 104, for example, by a network administrator. In some embodiments, an electronic communication device 104 may have two or more authorized users. The authorized users may have access to the electronic communication device 104 through a password and may then have access to applications and other software usable through the electronic communication device 104, which include applications and software for sending electronic messages.

In another embodiment, the authorized user of the electronic communication device 104 is a user that is the primary user of a communications application capable of sending the electronic messages. For example, the authorized user may be a user that primarily sends and receives email through an email application. In another example, the authorized user may be the primary user of a text messaging application where the text messages are sent through a phone number assigned to the authorized user.

The authorized user may temporarily allow use of the electronic communication device 104 to certain authorized proxy users and the verification module 204 may verify that the device user is an authorized proxy user. For example, the authorized user may be occupied and may want another person to send a message on the authorized user's behalf. For safety purposes, the authorized user may be driving and may ask the device user riding in the vehicle that the authorized user is driving to send an electronic message. In another example, the authorized user may be a presenter in a meeting and may want another person to send an email.

A problem may arise in that the device user attempting to send the electronic message may not phrase an electronic message in a way that the authorized user may phrase the message. For example, the device user attempting to send the electronic message may be a teenager and may use phrasing, words, slang, etc. that the authorized user would not use. The receiving party may be confused by the message and so the marking module 206 may mark the message as discussed below to prevent confusion.

In one embodiment where identity data is received using an input device, the verification module 204 may compare the identity data with verification data associated with one or more authorized proxy users to determine if the device user is an authorized proxy user. Verification data associated with an authorized proxy user may be stored as described below with regard to the authorization module 302 of the apparatus 300 of FIG. 3.

In one embodiment, the verification module 204 evaluates identity data as the identity data is received by the identity module and generates an identity probability based on the identity data. In the embodiment, the verification module 204 verifies that the device user is an authorized proxy user in response to determining that the identity probability exceeds an identity threshold.

For example, the electronic communication device 104 may include a touchscreen 114 that displays a virtual keyboard where the touchscreen 114 is capable of reading fingerprints. As the device user enters the electronic message, the verification module 204 may read partial fingerprints from the device user and may generate the identity probability. Where the identity probability remains below the identity threshold, the verification module 204 may fail to verify that the device user is an authorized proxy user. As more keys are pressed on the virtual keyboard, the device user may use different portions of the device user's finger so a more complete fingerprint of the device user may be identified and compared to fingerprint data of authorized proxy users, which may then raise the identity probability to level that exceeds the identity threshold where the identity data in the form of partial fingerprints matches verification data in the form of a fingerprint associated with an authorized proxy user.

In another example, the image data received through a camera 116 may include portions of the face of the device user entering the electronic message or may capture an image of a side of the device user's face, may capture an image that is not properly focused, may capture an image under low light conditions, etc. The verification module 204 may create an identity probability based on an image capturing part of the face, a side of the face, an out of focus image of the face, etc. of the device user and comparing the facial image data with one or more pictures of authorized proxy users. As the device user continues to use the electronic communication device 104 to enter the electronic message or other function, the camera 116 may capture different portions of the device user's face, may capture a more in-focus image, an image with better lighting, etc. which may then increase the identity probability where the image data matches a particular picture of a face of an authorized proxy user. Where the identity probability exceeds the identity threshold, the verification module 204 verifies that the device user is an authorized proxy user.

In some embodiments, the verification module 204 uses identity data from multiple input devices to create and update the identity probability. The verification module 204, in other embodiments, may use other identity data from other input devices, such as voice data from a microphone 118. The identity probability may be calculated, in one embodiment, based on the amount of identity data. For example, if one-eighth of a fingerprint is read and the partial fingerprint match a portion of one or more full fingerprints and the identity probability may be calculated from the partial fingerprint and the full fingerprints of authorized proxy users.

In one embodiment, the identity probability may be 0.125 percent, which may correspond to a match of one-eighth of a fingerprint. Where the finger is moved to add another one-eighth of a different part of a fingerprint, if the two portions match one or more full fingerprints of authorized proxy users, the identity probability may increase to 0.25 percent. As more fingerprint data is gathered, the verification module 204 may verify that the fingerprint data matches a single fingerprint of an authorized proxy user and the identity probability may increase above an identity threshold of 0.8 so that the verification module 204 verifies that the device user is an authorized proxy user. Other statistical methods may also be used to determine the identity probability and other identity thresholds may be used.

The apparatus 200 includes a marking module 206 that marks the electronic message being sent with an identifier in response to the verification module 204 verifying that the device user is an authorized proxy user. The identifier signifies that the electronic message is from the authorized proxy user. For example, the identifier may include the initials of the authorized proxy user, the name of the authorized proxy user, a photograph of the authorized proxy user, etc.

The identifier is in addition to an identifier associated with the authorized user. For example, where the electronic message is an email, the email may include an email address of the authorized user indicating that the email was sent from the email account of the authorized user. A receiving party of the electronic message, for example at the receiving device 108 may believe that the authorized user is responsible for the electronic message. The identifier associated with the authorized proxy user and included with the electronic message may notify the receiving party of the electronic message that the electronic message was at least entered by the authorized proxy user.

In one embodiment, the identifier is placed strategically with electronic message to notify the receiving party that the electronic message was created, typed, etc. by the authorized proxy user. For example, where the electronic message is a text message, the identifier may be placed in or next to the text message. Where the electronic message is an email, the identifier may be in the form of a sentence, initials, a name, etc. that may appear in the body of the email or in the email header. For example, the identifier may include: “John Smith sent this message on behalf of Pete Jones.” In another example, the identifier may simply include initials of the device user, such as “JS:” with the message following the identifier. One of skill in the art will recognize other identifiers and other ways to position an identifier with an electronic message to notify a receiving party that the electronic message was at least created by the authorized proxy user.

In one embodiment, the verification module 204 verifies that the device user is the authorized user and the marking module 206 sends the electronic message without an identifier in response to the verification module 204 verifying that the device user is the authorized user. For example, the identity module 202 may receive identity data from an input device and the verification module 204 may match the identity data with verification data associated with the authorized user. Where the authorized user is the device user, marking an electronic message with an identifier may be undesirable so the marking module 206 may not mark the electronic message with the identifier. In another embodiment, where the verification module 204 verifies that the device user is the authorized user, the marking module 206 may mark the electronic message being sent with an identifier that is associated with the authorized user. Marking the electronic message with an identifier that is associated with the authorized user may be beneficial, especially where previous electronic messages include an identifier associated with an authorized proxy user.

FIG. 3 is a schematic block diagram illustrating another embodiment of an apparatus 300 for message marking. The apparatus 300 has another embodiment of the marking apparatus 102 that includes an identity module 202, a verification module 204 and a marking module 206, which are substantially similar to those described above with regard to the apparatus 200 of FIG. 2. In various embodiments, the apparatus 300 includes an authorization module 302, a blocking module 304 and/or an authorization termination module 306, which are described below.

The apparatus 300, in some embodiments, includes an authorization module 302 that authorizes one or more authorized proxy users to send an electronic message from the electronic communication device 104. The one or more authorized proxy users are authorized by the authorized user of the electronic communication device 104. The authorized user may interact with the authorization module 302 at some previous time before a device user attempts to send the electronic message, such as days or weeks earlier, or the authorized user may interact with the authorization module 302 just before the device user attempts to send an electronic message to give instant authorization to the device user as an authorized proxy user.

In one embodiment, the authorization module 302 stores, for each authorized proxy user, verification data and an identifier. The verification module 204 verifies that the device user is an authorized proxy user based on the stored verification data associated with the authorized proxy user and the marking module 206 marks the message with the stored identifier associated with the authorized proxy user.

In one embodiment, the authorized user interacts with the authorization module 302 to authorize one or more authorized proxy users prior to the identity module 202 determining identity of a device user. The authorized user may include a name, initials, a photograph, etc. of an authorized proxy user. In another embodiment, an authorized proxy user inputs verification data, such as a fingerprint, voice data, a photograph, etc. The authorized proxy user may input verification data through input devices of the electronic communication device 104, such as a fingerprint scanner 112, a touchscreen 114, a camera 116, a microphone 118, a keyboard 120, etc. For example, the authorized proxy user may input verification data under direction of the authorized user.

The authorization module 302 may store the verification data in a data structure in the electronic communication device 104, or in a location accessible to the electronic communication device 104, such as a server 106 available through a computer network 110. The data structure includes at least verification data and an identifier of an authorized proxy user, but may also include other information useful to the authorized user, such as the name of the authorized proxy user.

In one embodiment, the verification module 204 receives an authorization from the authorized user in response to the identity module 202 determining that the device user is not an authorized proxy user. The authorization authorizes the device user to send the electronic message from the electronic communication device 104. For example, where a device user is not previously authorized, the device user may enter identity data and the verification module 204 may reject verification of the device user. The authorized user may then do an on-the-spot authorization of the device user.

To create an authorized proxy user, in one embodiment, the authorized user may initially login to the electronic communication device 104, may access an application with the authorization module 302 and may enter identity data, etc. to verify that the authorized user is entering data. The authorized user may then enter verification data or may work in conjunction with a potential authorized proxy user to enter validation data. In one example, the authorized user may hold a finger over a fingerprint scanner while taking a picture of the potential authorized proxy user. One of skill in the art will recognize other ways for the authorized user to authorize one or more authorized proxy users.

The apparatus 300, in some embodiments, includes a blocking module 304 that that terminates authorization of the device user and blocks sending of electronic messages by the device user in response to the verification module 204 determining that the device user not one or more of an authorized proxy user and the authorized user. The blocking module 304 may be used together with the identity module 202, the verification module 204, and the marking module 206 to mark messages for device users that are authorized proxy users and to block access to sending electronic messages for device users that are not authorized.

The blocking module 304 beneficially prevents unauthorized device users from sending unauthorized electronic messages. In another embodiment, the blocking module 304 also prevents access to other functions of the electronic communication device 104. In another embodiment, when the verification module 204 verifies that the device user is an authorized proxy user, the authorization module 302 or other module of the marking apparatus 102 allows access to an application for creating and sending electronic messages and the blocking module 304 blocks the device user from accessing functions of the electronic communication device 104 other than the electronic messaging application(s). One of skill in the art will recognize other ways that the blocking module 304 may limit access of an authorized and/or unauthorized device user.

The apparatus 300 includes, in some embodiments, an authorization termination module 306 that terminates authorization of the device user and stops marking electronic messages sent from the electronic communication device with an identifier. The authorization termination module 306 may terminate authorization in response to various occurrences. For example, the authorization termination module 306 may terminate authorization of the device user in response to a timeout that returns the electronic communication device 104 to a state requiring an authentication action by the authorized user. For example, the timeout may be in response to a lack of activity, such as a lack of input through an input device in communication with the electronic communication device 104. The timeout may be a typical timeout used by various electronic communication devices 104 to log out after inactivity.

In another example, the authorization termination module 306 may terminate authorization of the device user in response to expiration of an authorization time-period. The authorization time-period may be independent of any activity on the electronic communication device 104. For example, the authorization time-period may expire even though the electronic communication device 104 is active and receiving input from an input device. In another embodiment, the authorization termination module 306 may terminate authorization of the device user in response to a determination that the authorized user is using the electronic communication device 104. For example, the identity module 202 may receive identity data consistent with the authorized user being the device user, for example, after taking control of the electronic communication device 104 from an authorized proxy user.

In another example, the authorization termination module 306 prevents the device user from sending electronic messages from the electronic communication device in response to the authorization termination module terminating authorization. In some embodiments, the authorization termination module 306 works in conjunction with the blocking module 304 to block access to the electronic communication device 104.

In one embodiment, the identity module 202 repeats determining the identity of the device user and the verification module 204 verifies that the device user is an authorized proxy user in response to each determination of identity, and the marking module 206 continues to mark each electronic message sent by the device user from the electronic communication device 104 of the authorized user in response to continued verification that the device user is an authorized proxy user. The continued verification of the device user as an authorized proxy user may delay the authorization termination module 306 from terminating authorization in some embodiments.

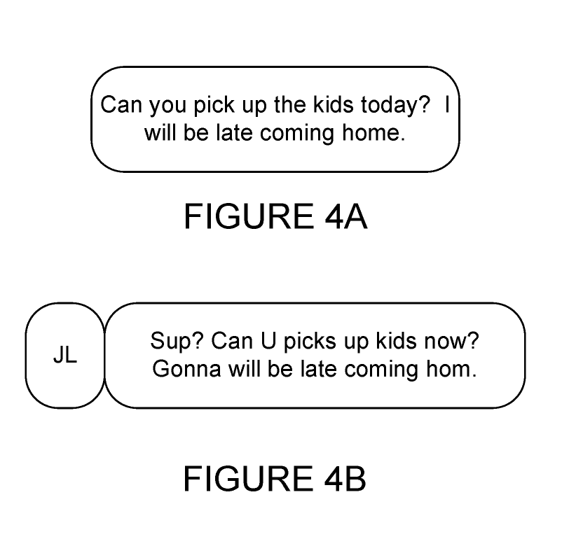

FIG. 4A is a diagram illustrating an intended electronic message. For example, the authorized user may be an adult wanting to send a message to a spouse or other person to pick up the children of the authorized user. FIG. 4B is a diagram illustrating an electronic message by an authorized proxy user marked with an identifier. In the message of the device user that is an authorized proxy user, the device user may use language that is different than the authorized user would want to send. For example, the device user may use slang, such as “sup,” which may be interpreted as “what's up,” or “gonna,” which may be interpreted as “I am going to.” The device user may also use in correct grammar, for example using “picks” instead of “pick,” which may be typographical error that the authorized user may not make or may correct.

The device user may also use letters intended to save keystrokes, such as “U” instead of “you.” The end result is that the electronic message of the device user on behalf of the authorized user may be confusing to a receiving party, may cause a lower opinion of the authorized user by the receiving party, or may cause the receiving party to not believe the message because the receiving party may recognize that the authorized user would choose other language. The message includes the identifier “JL,” which may be initials of the device user that is an authorized proxy user. By including the identifier, the receiving party may recognize that the authorized user is having another person send the electronic message.

Other situations may also be appropriate for marking electronic messages from an authorized proxy user. For example, marking electronic messages of an authorized proxy user may alert a receiving party in business transactions or other situations where sensitive messages are being exchanged so that the receiving party is aware that the authorized proxy user is present in the conversation. In other instances, for example where the marking apparatus 102 includes the blocking module 304 and/or the authorization termination module 306 and where the identity module 202 repeats verification of a device user, the authorized user may be able to point to an identifier attached to an electronic message as evidence that the authorized user did not send an electronic message, such as an insulting message, a vulgar message, etc. In other situations, electronic messages sent without an identifier may be associated with the authorized user and the authorized user may have less of an ability to claim someone else sent an electronic message.

In another embodiment, for example where the marking apparatus 102 prevents sending messages from unauthorized parties, the marking apparatus 102 may either send an identifier for an authorized proxy user when the device user is an authorized proxy user or an identifier of the authorized user when the device user is the authorized user. The receiving device 108 may accept messages with an identifier and may reject messages lacking an identifier. The marking apparatus 102 may then be used to validate electronic messages so that electronic messages from unauthorized parties may be rejected.

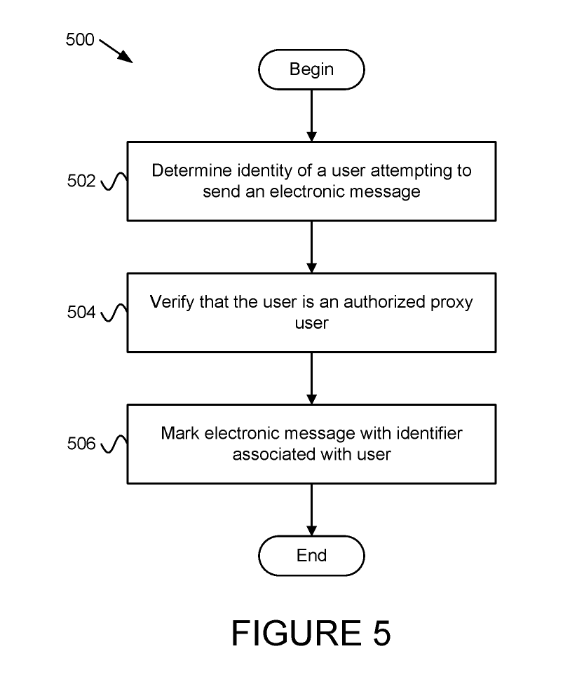

FIG. 5 is a schematic flow chart diagram illustrating one embodiment of a method 500 for message marking. The method 500 determines 502 identity of a device user attempting to send an electronic message from an electronic communication device 104 of an authorized user and the method 500 verifies 504 that the device user is an authorized proxy user. The method 500 marks 506 the electronic message being sent with an identifier in response to verifying 504 that the device user is an authorized proxy user. The identifier signifies that the electronic message is from the authorized proxy user and the identifier is in addition to an identifier associated with the authorized user. The method 500, in one embodiment, may be implemented using the identity module 202, the verification module 204 and/or the marking module 206.

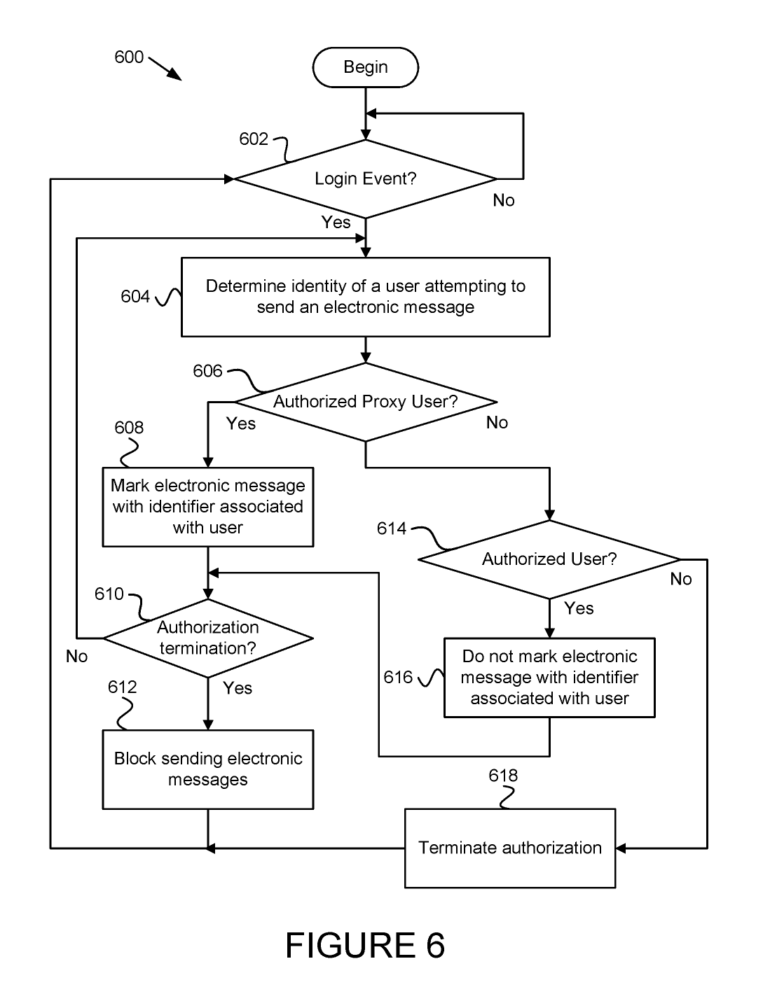

FIG. 6 is a schematic flow chart diagram illustrating another embodiment of a method 600 for message marking. The method 600 determines 602 if there is a login event or similar authorization to access the electronic communication device 104. If the method 600 determines 602 that there is not a login event, the method 600 returns to monitor for a login event. If the method 600 determines 602 that there is a login event, the method 600 determines 604 identity of a device user attempting to send an electronic message from an electronic communication device 104 of an authorized user.

The method 600 determines 606 if the device user is an authorized proxy user. If the method 600 determines 606 that the device user is an authorized proxy user, the method 600 marks 608 electronic messages sent from the electronic communication device 104 with an identifier associated with the authorized proxy user. The identifier signifies that the electronic message is from the authorized proxy user and the identifier is in addition to an identifier associated with the authorized user. The method 600 determines 610 if the authorization of the device user is terminated. If the method 600 determines that the authorization is terminated, the method 600 returns and determines 604 identity of the device user. If the method 600 determines that the authorization is not terminated, the method 600 blocks 612 sending of electronic messages by the authorized proxy user and the method 600 returns to determine 602 if there is a login event.

If the method 600 determines that the device user is not an authorized proxy user, the method 600 determines 614 if the device user is the authorized user. If the method 600 determines 614 that the device user is the authorized user, the method 600 does not mark electronic messages with an identifier associated with an authorized proxy user. The method 600 then determines 610 if there is an authorization termination. If the method 600 determines 614 that the device user is not the authorized user, the method 600 terminates authorization and may also return the electronic communication device 104 to a sleep state. The method 600 returns to determine if there is a login event. In one embodiment, the method 600 may be implemented using the identity module 202, the verification module 204, the marking module 206, the authorization module 302, the blocking module 304 and/or the authorization termination module 306.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
an identity module that determines an identity of a device user attempting to send an electronic message from an electronic communication device of an authorized user;
a verification module that verifies that the device user is an authorized proxy user; and
a marking module that marks the electronic message being sent with an identifier in response to verifying that the device user is an authorized proxy user, the identifier signifying that the electronic message is from the authorized proxy user, the identifier in addition to an identifier associated with the authorized user,
wherein at least a portion of said modules comprise one or more of hardware circuits, a programmable hardware device and executable code, the executable code stored on one or more computer readable storage media.

2. The apparatus of claim 1, further comprising an authorization module that authorizes one or more authorized proxy users to send an electronic message from the electronic communication device, the one or more authorized proxy users authorized by the authorized user of the electronic communication device.

3. The apparatus of claim 2, wherein the authorization module stores, for each authorized proxy user, verification data and an identifier and wherein the verification module verifies that the device user is an authorized proxy user based on the stored verification data associated with the authorized proxy user and the marking module marks the message with the stored identifier associated with the authorized proxy user.

4. The apparatus of claim 1, wherein the verification module receives an authorization from the authorized user in response to the identity module determining that the device user is not an authorized proxy user, the authorization authorizing the device user to send the electronic message from the electronic communication device.

5. The apparatus of claim 1, wherein the identity module electronically determines an identity of the device user from identity data received through an input device in communication with the electronic communication device and wherein the verification module compares the identity data with verification data associated with one or more authorized proxy users to determine whether the device user is an authorized proxy user.

6. The apparatus of claim 5, wherein the identity data comprises one or more of:
fingerprint data received from one or more of a fingerprint scanner and a touchscreen of the electronic communication device;
an image of the device user received from a camera in communication with the electronic communication device;
voice data received from a microphone in communication with the electronic communication device; and
a password entered by the device user.

7. The apparatus of claim 5, wherein the identity module receives the identity data while the device user is inputting the electronic message.

8. The apparatus of claim 7, wherein the verification module evaluates identity data as the identity data is received by the identity module and generates an identity probability based on the identity data, wherein the verification module verifies that the device user is an authorized proxy user in response to determining that the identity probability exceeds an identity threshold.

9. The apparatus of claim 1, wherein the identity module repeats determining the identity of the device user and the verification module verifies that the device user is an authorized proxy user in response to each determination of identity, and wherein the marking module marks each electronic message sent by the device user from the electronic communication device of the authorized user in response to continued verification that the device user is an authorized proxy user.

10. The apparatus of claim 9, further comprising a blocking module that terminates authorization of the device user and blocks sending of electronic messages by the device user in response to the verification module determining that the device user not one or more of an authorized proxy user and the authorized user.

11. The apparatus of claim 1, further comprising an authorization termination module that terminates authorization of the device user and stops marking electronic messages sent from the electronic communication device with an identifier in response to one or more of:
a timeout that returns the electronic communication device to a state requiring an authentication action by the authorized user;
expiration of an authorization time-period; and
a determination that the authorized user is using the electronic communication device.

12. The apparatus of claim 11, wherein the authorization termination module prevents the device user from sending electronic messages from the electronic communication device in response to the authorization termination module terminating authorization.

13. The apparatus of claim 1, wherein the verification module further verifies that the device user is the authorized user and wherein the marking module sends the electronic message without an identifier in response to the verification module verifying that the device user is the authorized user.

14. A method comprising:
determining identity of a device user attempting to send an electronic message from an electronic communication device of an authorized user;
verifying that the device user is an authorized proxy user; and
marking the electronic message being sent with an identifier in response to verifying that the device user is an authorized proxy user, the identifier signifying that the electronic message is from the authorized proxy user, the identifier in addition to an identifier associated with the authorized user.

15. The method of claim 14, further comprising:
authorizing one or more authorized proxy users to send an electronic message from the electronic communication device, the one or more authorized proxy users authorized by the authorized user of the electronic communication device; and
storing, for each authorized proxy user, verification data and an identifier and wherein verifying that the device user is an authorized proxy user is based on the stored verification data associated with the authorized proxy user and wherein marking the electronic message with the identifier comprises marking the message with the stored identifier associated with the authorized proxy user.

16. The method of claim 14, wherein determining identity of the device user comprises electronically determining identity of the device user from identity data received through an input device in communication with the electronic communication device and wherein verifying that the device user is an authorized user comprises comparing the identity data with verification data associated with one or more authorized proxy users to determine whether the device user is an authorized proxy user.

17. The method of claim 16, wherein the identity data comprises one or more of:
fingerprint data received from one or more of a fingerprint scanner and a touchscreen of the electronic communication device;
an image of the device user received from a camera in communication with the electronic communication device;
voice data received from a microphone in communication with the electronic communication device; and
a password received from the device user.

18. The method of claim 16, wherein determining identity of the device user comprises receiving the identity data while the device user is inputting the electronic message and wherein determining identity of the device user comprises evaluating identity data as the identity data is received and further comprising generating an identity probability based on the identity data, wherein verifying that the device user is an authorized proxy user is in response to determining that the identity probability exceeding an identity threshold.

19. The method of claim 14, further comprising terminating authorization of the device user and stopping marking electronic messages sent from the electronic communication device with an identifier in response to one or more of:
a timeout that returns the electronic communication device to a state requiring an authentication action by the authorized user;
expiration of an authorization time-period; and
a determination that the authorized user is using the electronic communication device.

20. A computer program product comprising a computer readable storage medium having program instructions embodied therewith, the program instructions executable by a processor to cause the processor to:
determine an identity of a device user attempting to send an electronic message from an electronic communication device of an authorized user;
verify that the device user is an authorized proxy user; and
mark the electronic message being sent with an identifier in response to verifying that the device user is an authorized proxy user, the identifier signifying that the electronic message is from the authorized proxy user, the identifier in addition to an identifier associated with the authorized user.
